(19) United States
(12) Patent Application Publication
(10) Pub. No.: US 2020/0176933 A1
(43) Pub. Date: Jun. 4, 2020

(54) HIGH FREQUENCY CONNECTOR

(71) Applicant: SPEED TECH CORP., Taoyuan City (TW)

(72) Inventors: Chih-Cheng CHEN, Taoyuan City (TW); I-Ting HSIEH, Taoyuan City (TW)

(73) Assignee: SPEED TECH CORP., Taoyuan City (TW)

(21) Appl. No.: 16/699,928

(22) Filed: Dec. 2, 2019

(30) Foreign Application Priority Data
Dec. 3, 2018 (TW) 107143279

(51) Int. Cl. H01R 13/6477; H01R 13/6474; H01R 13/502; H01R 13/11

(52) U.S. Cl. CPC H01R 13/6477; H01R 13/11; H01R 13/502; H01R 13/6474

(57) ABSTRACT

A high frequency connector includes a first and a second contact array arranged along a first direction, a first and a second insulative carrier, a housing surrounding the first and the second contact array, and at least one impedance adjusting element. The second contact array is reversely arranged side by side with the first contact array. The first and the second insulative carrier respectively cover the first and the second contact array. The housing is engaged with the first and the second insulative carrier. The impedance adjusting element includes a base and a plurality of plates. The base includes a first and a second surface connected with each other and forming a turning angle, and a third surface engaged with the housing. A contact of the first or the second contact array includes an adjusting region. The plates and the adjusting regions are staggered along the first direction.

### CROSS-REFERENCE TO RELATED APPLICATION

This application claims priority to Taiwan Application Serial Number 107143279, filed Dec. 3, 2018, which is herein incorporated by reference in its entirety.

### BACKGROUND

### Field of Invention

The present invention relates to a connector. More particularly, the present invention relates to a high frequency connector.

### Description of Related Art

A typical straddle high frequency connector is applied for electrically coupling with a circuit board. However, as the frequency of the information transmission increases, the influence of the grounding distance between the ground terminal (solder point) and the contact on the high frequency electrical property becomes dominant. Typically, in order to satisfy the electrical property requirement and be compatible with the circuit boards with different thicknesses, design for the contacts of the connector should be adjusted to control the high frequency electrical property, for example, impedance and return loss.

Furthermore, when a center of the circuit board is deviated (that is, the distances between the ground terminal and the two rows of contacts are different), the performance of the high frequency connector is easier to be affected by the impedance mismatch. If the turning angles of the contacts are designed individually based on the circuit board thickness and the position, developing cost would be increased and the products would have low compatibility. Accordingly, it is critical to provide an adjusting structure that can compensate the mismatch or deviation of the electrical property of the high frequency connector and has a high compatibility.

### SUMMARY

The invention provides a high frequency connector for coupling with a circuit board.

It is to be understood that both the foregoing general description and the following detailed description are by examples, and are intended to provide further explanation of the invention as claimed.

In some embodiments, the high frequency connector includes a first contact array and a second contact array, a first insulative carrier and a second insulative carrier, a housing, and at least one impedance adjusting element. The first contact array and the second contact array are arranged along a first direction. The second contact array is reversely arranged side by side with the first contact array along a second direction perpendicular to the first direction. The first insulative carrier and the second insulative carrier respectively covering a portion of the first contact array and a portion of the second contact array. The housing surrounds the first contact array and the second contact array, and the housing is engaged with the first insulative carrier and the second insulative carrier. The impedance adjusting element includes a base and a plurality of plates extending from the base. The base includes a first surface, a second surface, and a third surface. The first surface and the second surface are connected with each other and form a turning angle. The third surface is configured to be engaged with the housing. A contact of the first contact array or the second contact array includes an adjusting region. The plates of the impedance adjusting element and the adjusting regions are staggered along the first direction.

In some embodiments, the first contact array or the second contact array has a contact point in contact with the circuit board. The adjusting regions and the corresponding contact point have a grounding distance therebetween along the second direction. The grounding distance of the first contact array is greater than the grounding distance of the second contact array, and the plates of the impedance adjusting element and the adjusting regions of the first contact array are staggered along the first direction.

In some embodiments, the grounding distance of the first contact array is substantially equal to the grounding distance of the second contact array. The number of the impedance adjusting element is two, and the plates of the impedance adjusting elements and the adjusting regions of the first contact array and the second contact array are staggered along the first direction.

In some embodiments, the first surface and each of the adjusting regions has a gap therebetween, and the second surface and each of the adjusting regions has a gap therebetween.

In some embodiments, each of the plates and adjacent one of the adjusting regions has a gap therebetween.

In some embodiments, the adjusting region has a turning position, the turning position has an adjusting angle, and the adjusting angle is different from the turning angle.

In some embodiments, the turning angle is an obtuse angle.

In some embodiments, the impedance adjusting element further includes a protruding portion, and the housing includes a through hole configured to engage with the protruding portion.

In some embodiments, the impedance adjusting element further includes a sliding block, and the housing includes a sliding groove configured to engage with the sliding block.

In some embodiments, the impedance adjusting element further includes a top surface in contact with the first insulative carrier or the second insulative carrier.

### BRIEF DESCRIPTION OF THE DRAWINGS

The invention can be more fully understood by reading the following detailed description of the embodiment, with reference made to the accompanying drawings as follows:

FIG. 1 is a perspective view of a high frequency connector electrically coupled with a circuit board according to an embodiment of the present disclosure;

FIG. 2 is a perspective view of a high frequency connector according to an embodiment of the present disclosure, and some structures are separated from the high frequency connector;

FIG. 3 is a partial cross-sectional perspective view of the impedance adjusting element according to an embodiment of the present disclosure;

FIG. 4 is a cross-sectional view along the line 4-4 in FIG. 2;

FIG. 5 is a cross-sectional view along the line 5-5 in FIG. 2;

FIG. 6 is a cross-sectional view along the line 6-6 in FIG. 1;

FIG. 7 is a cross-sectional view of a high frequency connector electrically coupled with a circuit board according to another embodiment of the present disclosure;

FIG. 8 is a plot of impedance to time measured when the high frequency connector is assemble with and not assembled with the impedance adjusting element according to an embodiment of the present disclosure; and

FIG. 9 is a plot of return loss to frequency measured when the high frequency connector is assemble with and not assembled with the impedance adjusting element according to an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

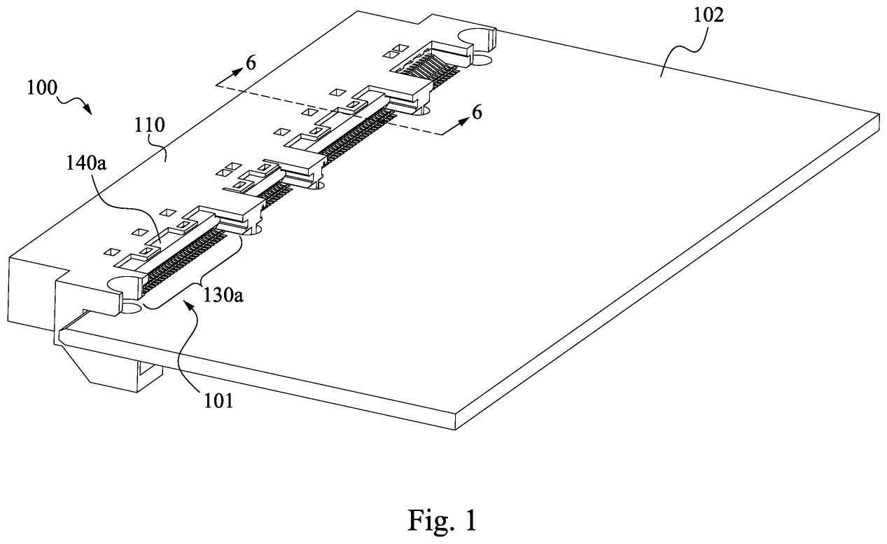

FIG. 1 is a perspective view of a high frequency connector 100 electrically connected with a circuit board 102 according to an embodiment of the present disclosure. The high frequency connector 100 includes a housing 110, a first contact array 130a and an impedance adjusting element 140a. The impedance adjusting element 140a is made of insulative material, for example, plastic. In the present embodiment, the high frequency connector 100 is a straddle connector. A bottom 101 of the high frequency connector 100 can be applied for connecting with circuit boards 102 with different thicknesses. For example, in some embodiments, the thickness of the circuit board 102 is located in a range from about 1.57 mm to about 2.36 mm.

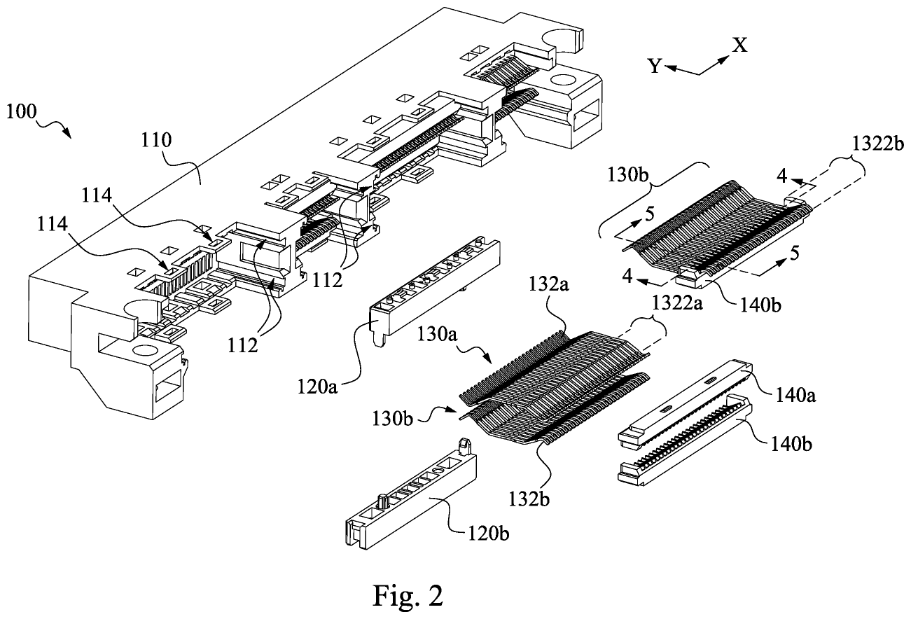

FIG. 2 is a perspective view of the high frequency connector 100 in FIG. 1, and some structures are separated from the high frequency connector 100. The high frequency connector 100 further includes a first insulative carrier 120a, a second insulative carrier 120b and a second contact array 130b. The first contact array 130a and the second contact array 130b are arranged along a first direction X. The first contact array 130a and the second contact array 130b respectively has a plurality of first contacts 132a and a plurality of second contacts 132b, which are reversely arranged side by side along a second direction Y perpendicular to the first direction X. The first insulative carrier 120a and the second insulative carrier 120b respectively cover a portion of the first contact array 130a and a portion of the second contact array 130b, so as to fix relative positions between the first contacts 132a and the second contacts 132b. The housing 110 surrounds the first contact array 130a and the second contact array 130b, and the housing 110 is engaged with the first insulative carrier 120a and the second insulative carrier 120b.

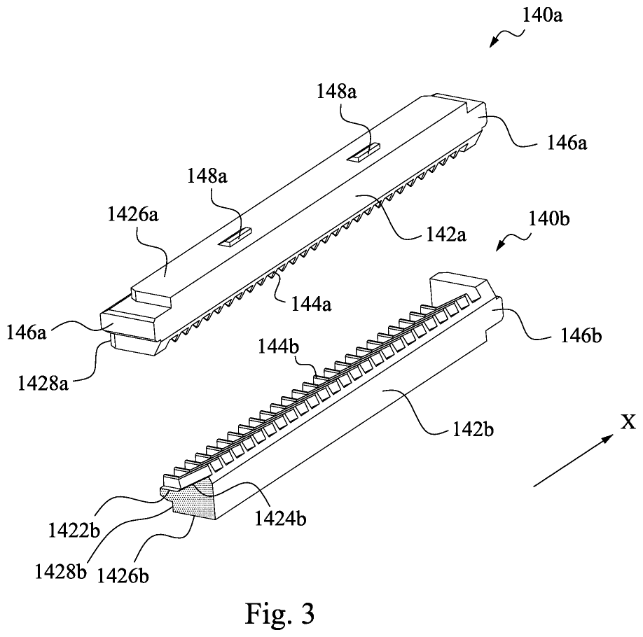

FIG. 3 is a partial cross-sectional perspective view of the impedance adjusting element 140a-140b according to an embodiment of the present disclosure. The impedance adjusting element 140b in FIG. 3 has a cross sectional view perpendicular to the first direction X. It is noted that, the impedance adjusting element 140a-140b in FIG. 2 have substantially the same structures. The impedance adjusting element 140a-140b respectively have bases 142a, 142b. The base 142b has a first surface 1422b and a second surface 1424b. Similarly, the base 142a also has a first surface 1422a and a second surface 1424a. The base 142a, 142b respectively have third surfaces 1426a, 1426b. The impedance adjusting element 140a-140b respectively have a plurality of plates 144a, 144b. The first surface 1422b and the second surface 1424b are connected with each other and form an turning angle θ 1 and the turning angle θ 1 is an obtuse angle. The third surface 1426b faces the first surface 1422b and the second surface 1424b. The plate 144b extends from a side of the first surface 1422b and the second surface 1424b away from the third surface 1426b, and is arranged along the first direction X. In the present embodiments, the plate 144b extends outward from the first surface 1422b and the second surface 1424b, and the plate 144b is substantially perpendicular to the first surface 1422b and the second surface 1424b.

Reference is made to FIG. 1 to FIG. 3. The impedance adjusting element 140a is located between the housing 110 and the first contact array 130a, and the impedance adjusting element 140b is located between the housing 110 and the second contact array 130b. The first surface 1422a and the second surface 1424a of the impedance adjusting element 140a is located at a side close to the first contact array 130a, and the first surface 1422b and the second surface 1424b of the impedance adjusting element 140b is located at a side close to the second contact array 130b. The third surfaces 1426a, 1426b are located at a side close to the housing 110. The first contacts 132a of the first contact array 130a each has an adjusting region 1322a, and the second contacts 132b of the second contact array 130b each has an adjusting region 1322b. The adjusting regions 1322a, 1322b and the plates 144a, 144b of the impedance adjusting element 140a, 140b are respectively staggered along the first direction X1. That is, the adjusting regions 1322a is a section of the first contacts 132a that is arranged side by side with the impedance adjusting element 140a along the second direction Y, and the adjusting regions 1322b is a section of the second contacts 132b that is arranged side by side with the impedance adjusting element 140b along the second direction Y.

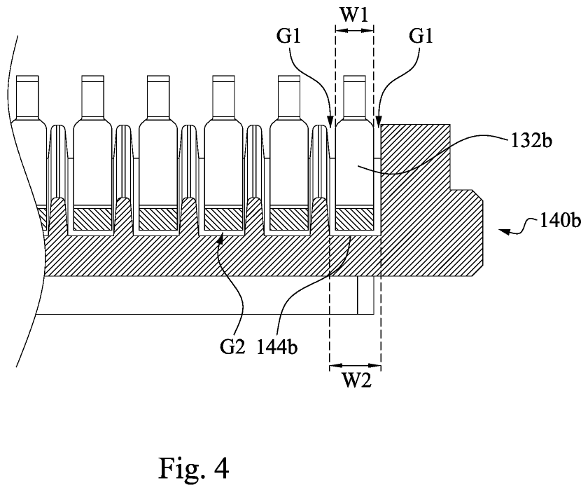

FIG. 4 is a cross-sectional view along the line 4-4 in FIG. 2. In the present embodiment, the adjusting regions 1322b (see FIG. 2) of the second contacts 132b each has a width W1, the adjacent two plates 144b have a width W2 therebetween, and the width W2 is greater than the width W1. In other words, each of the adjusting regions 1322a and the adjacent two plates 144b respectively have a gap G1. Furthermore, each of the first contacts 132a and the second surface 1424b has a gap G2.

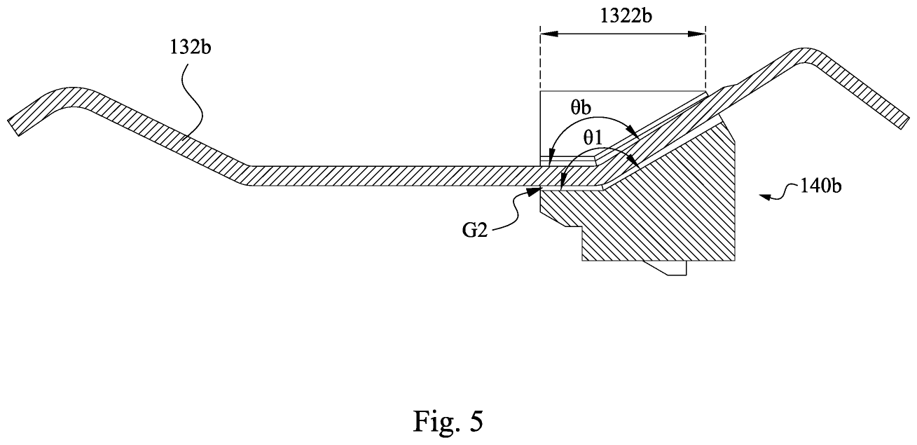

FIG. 5 is a cross-sectional view along the line 5-5 in FIG. 2. Each of the second contacts 132b of the second contact array 130b has a turning position, and the turning position forms an adjusting angle θ b. In some embodiments, the adjusting angle θ b of the adjusting regions 1322b of the second contact 132b is different from the turning angle θ 1 of the impedance adjusting element 140b. Similarly, each of the first contacts 132a of the first contact array 130a has a turning position, and the turning position forms an adjusting angle different from the turning angle θ 1 of the impedance adjusting element 140a. In some other embodiments, the adjusting angles of the first contacts 132a and the second contacts 132b can be the same as the turning angles of the impedance adjusting element 140a, 140b.

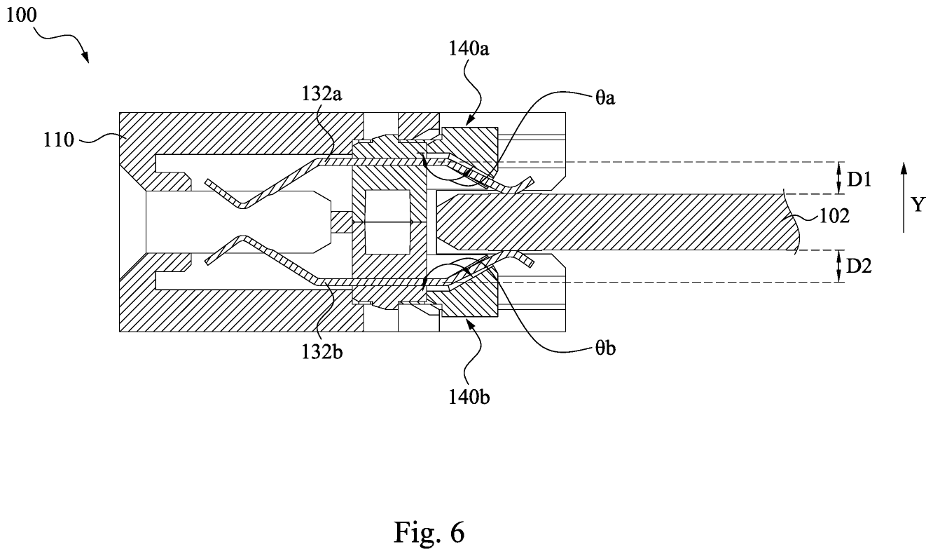

FIG. 6 is a cross-sectional view along the line 6-6 in FIG. 1. In the present embodiment, the high frequency connector 100 is electrically coupled with the circuit board 102. The thickness of the circuit board 102 is about 1.57 mm, and a center of the circuit board 102 along the second direction Y is substantially aligned with a center of the high frequency connector 100 along the second direction Y. That is, the grounding distance D1 between the first contacts 132a to the circuit board 102 and the grounding distance D2 between the second contacts 132b to the circuit board 102 are substantially the same. In the present embodiment, the impedance adjusting element 140a is mounted between the first contact array 130a and the housing 110, and the impedance adjusting element 140b is mounted between the second contact array 130b and the housing 110. As such, the electrical property of the high frequency connector 100 can be fine-tuned and be improved.

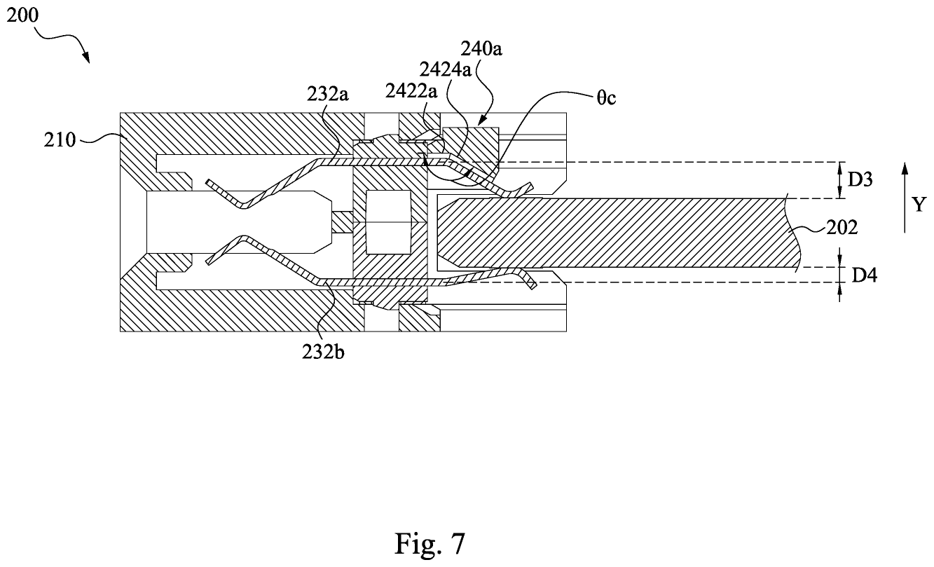

FIG. 7 is a cross-sectional view of a high frequency connector 200 electrically coupled with a circuit board 202 accordingly to another embodiment of the present disclosure. In the present embodiment, a thickness of the circuit board 202 is about 2.36 mm, and a center of the circuit board 202 along the second direction Y is deviated from a center of the high frequency connector 200 along the second direction Y. That is, the grounding distance D3 between the first contacts 232a to the circuit board 202 and the grounding distance D4 between the second contacts 232b to the circuit board 202 are different. In the present embodiment, the impedance adjusting element 240a is mounted between the first contact array 230a and the housing 210. There is no need to mount the impedance adjusting element between the second contact array 230b and the housing 210. The impedance adjusting element 240a is configured to match the impedance of the high frequency connector 100.

According to the embodiments shown in FIG. 6 and FIG. 7, the impedance adjusting element in the present disclosure may be applicable for high frequency connector that is coupled with circuit boards with different thicknesses and/or different center positions. Users may mount the impedance adjusting element onto the high frequency connector based on the electrical property requirement of the products. Accordingly, the impedance adjusting element of the present disclosure has high compatibility, and the developing cost for controlling the electrical property of the high frequency connector can be reduced.

Specifically, the impedance adjusting elements with the same turning angle θ 1 may be used to adjust impedance of the high frequency connectors with different adjusting angle θ a and adjusting angle θ b to match the impedance. For example, in the embodiment shown in FIG. 7, the turning angle θ 1 (see FIG. 5) is substantially the same as the adjusting angle θ c. Therefore, the gap between the adjusting regions of the first contacts 232a (that is, the sections of the first contacts 232a arranged side by side with the impedance adjusting element 240a along the second direction Y) and the first surface 2422a is substantially a constant. The gap between the adjusting regions of the first contacts 232a and the second surface 2424a is substantially a constant.

Furthermore, in the embodiment shown in FIG. 6, the turning angle θ 1 (see FIG. 5) are different from the adjusting angles θ a, θ b. Therefore, the gap between the adjusting regions 1322a (see FIG. 2) of the first contacts 132a and the first surface 1422a and the gap between the adjusting regions 1322a of the first contacts 132a and the second surface 1424a may be in a range. Similarly, the gap between the adjusting regions 1322b (see FIG. 2) of the second contacts 132b and the first surface 1422b and the gap between the adjusting regions 1322b of the second contacts 132b and the second surface 1424b may be in a range. That is, the gaps relative to the first surfaces 1422a, 1422b and the second surfaces 1424a, 1424b are not contact values.

However, in some embodiments, the first contacts 132a may be in contact with the first surface 1422a or the second surfaces 1424a, and the second contacts 132b may also be in contact with the first surface 1422b or the second surface 1424b. The aforementioned design of the angels should be determined by the requirement of the products, and the present disclosure is not limited in this regard.

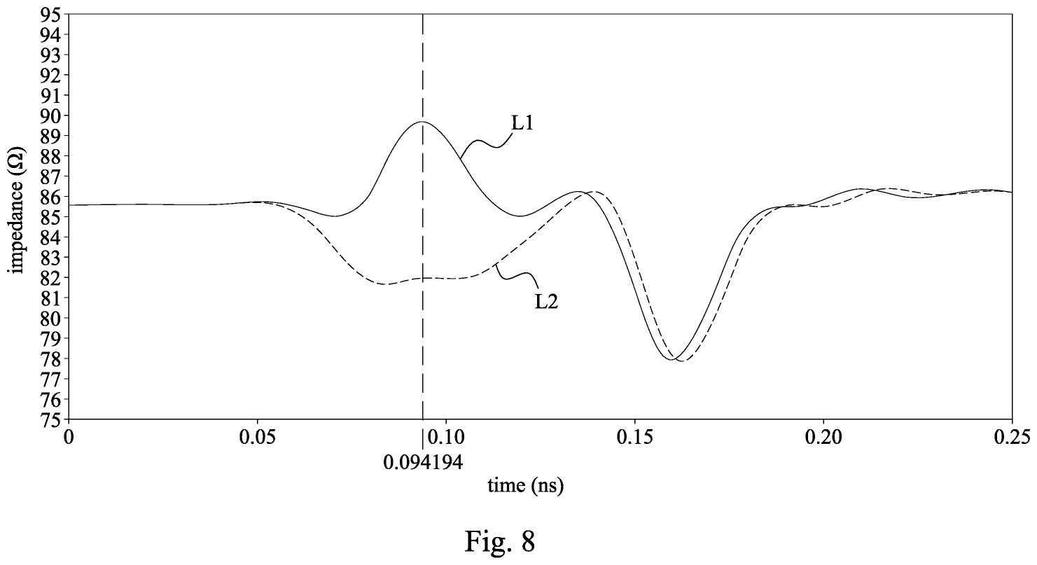

FIG. 8 is a plot of impedance to time measured when the high frequency connector is assemble with and not assembled with the impedance adjusting element according to an embodiment of the present disclosure. In the present embodiment, the curve L1 represents the impedance measured by the time domain reflectometry when the impedance adjusting element is not mounted on the high frequency connector. The curve L2 represents the impedance measured when the impedance adjusting element is mounted on the high frequency connector. As shown in the FIG. 8, when the impedance adjusting element is not mounted on the high frequency connector, a higher reflection quantity is measured by the time domain reflectometry. As shown by curve L2, the impedance adjusting element may reduce the impedance to further improve the impedance mismatch.

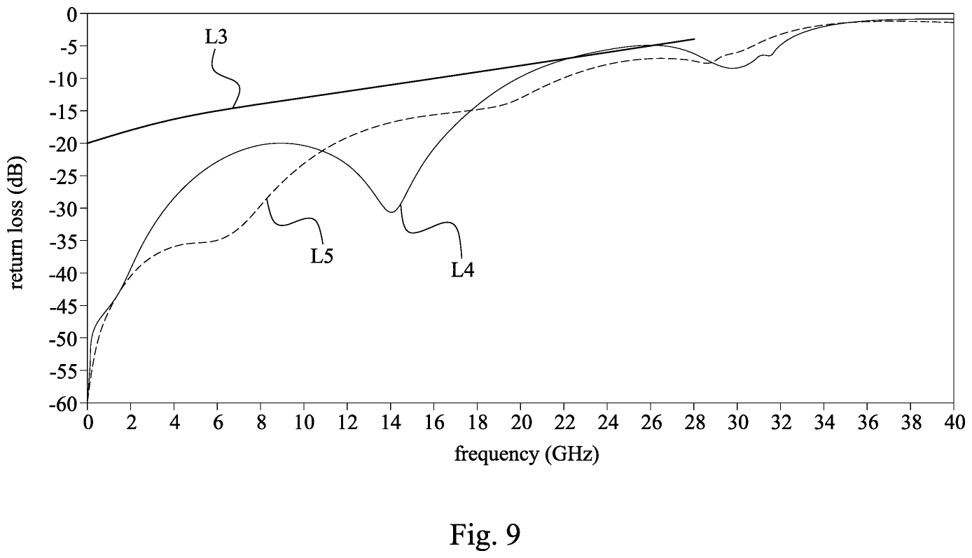

FIG. 9 is a plot of return loss to frequency measured when the high frequency connector is assemble with and not assembled with the impedance adjusting element according to an embodiment of the present disclosure. In the present embodiment, the curve L3 represents a limit line of the return loss. The curve L4 represents the return loss measured when the impedance adjusting element is not mounted on the high frequency connector, and the curve L5 represents the return loss measured when the impedance adjusting element is mounted on the high frequency connector. As shown in FIG. 9, in the high frequency section, the impedance of the high frequency connector without the impedance adjusting element approximates to the value shown by the curve L3, and the return loss is decreased after the impedance adjusting element is mounted, thereby improving the signal transmission quality.

Reference is made to FIG. 2 and FIG. 3 again. In the present embodiment, the housing 110 has four sliding grooves 112. The sliding grooves 112 are respectively located at two ends of the housing 110 along the first direction. The impedance adjusting elements 140a, 140b respectively have sliding blocks 146a, 146b. The sliding blocks 146a, 146b respectively protrudes from two ends of the impedance adjusting elements 140a, 140b along the first direction X. The impedance adjusting elements 140a, 140b further includes top surfaces 1428a, 1428b. When the impedance adjusting elements 140a, 140b are about to be mounted onto the high frequency connector 100, along the direction as shown by the arrow A, the impedance adjusting elements 140a, 140b respectively slide from the bottom 101 of the high frequency connector 100 along the slide grooves 112 through the sliding blocks 146a, 146b until the top surface 1428a of the impedance adjusting element 140a is in contact with the first insulative carrier 120a and the top surface 1428b of the impedance adjusting element 140b is in contact with the second insulative carrier 120b.

Furthermore, the housing 110 further includes two through holes 114 respectively located at two side walls of the housing 110 along the second direction Y close to the bottom 101. The impedance adjusting element 140a has two protruding portions 148a. Similarly, the impedance adjusting element 140b also has two protruding portions 148b, respectively protruded from the third surfaces 1426a, 1426b. After the impedance adjusting elements 140a, 140b are slide to be in contact with the first insulative carrier 120a and the second insulative carrier 120b, the protruding portion 148a of the impedance adjusting element 140a and the protruding portion of the impedance adjusting element 140b are respectively engaged with the through holes 114, so as to fix the impedance adjusting elements 140a, 140b relative to the housing 110.

Accordingly, with the sliding mechanism between the sliding groove and the sliding block, and with the engaging mechanism between the protruding portion and the through hole, the impedance adjusting element can be assembled and disassembled conveniently. It is beneficial for users to change the number and the position of the required impedance adjusting elements.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A high frequency connector configured to be coupled with a circuit board, comprising:
a first contact array and a second contact array arranged along a first direction, wherein the second contact array is reversely arranged side by side with the first contact array along a second direction perpendicular to the first direction;
a first insulative carrier and a second insulative carrier respectively covering a portion of the first contact array and a portion of the second contact array;
a housing surrounding the first contact array and the second contact array, and the housing is engaged with the first insulative carrier and the second insulative carrier; and
at least one impedance adjusting element, comprising:
a base, comprising:
a first surface and a second surface connected with each other and form a turning angle; and
a third surface configured to be engaged with the housing; and
a plurality of plates extending from the base, wherein a contact of the first contact array or the second contact array comprises an adjusting region, and the plates of the impedance adjusting element and the adjusting regions are staggered along the first direction.

2. The high frequency connector of claim 1, wherein the first contact array or the second contact array has a contact point in contact with the circuit board, the adjusting regions and the corresponding contact point have a grounding distance therebetween along the second direction, the grounding distance of the first contact array is greater than the grounding distance of the second contact array, and the plates of the impedance adjusting element and the adjusting regions of the first contact array are staggered along the first direction.

3. The high frequency connector of claim 1, wherein the first contact array or the second contact array has a contact point in contact with the circuit board, the adjusting regions and the corresponding contact point have a grounding distance therebetween along the second direction, wherein the grounding distance of the first contact array is substantially equal to the grounding distance of the second contact array, the number of the impedance adjusting element is two, and the plates of the impedance adjusting elements and the adjusting regions of the first contact array and the second contact array are staggered along the first direction.

4. The high frequency connector of claim 1, wherein the first surface and each of the adjusting regions has a gap therebetween, and the second surface and each of the adjusting regions has a gap therebetween.

5. The high frequency connector of claim 1, wherein each of the plates and adjacent one of the adjusting regions has a gap therebetween.

6. The high frequency connector of claim 1, wherein the adjusting region has a turning position, the turning position has an adjusting angle, and the adjusting angle is different from the turning angle.

7. The high frequency connector of claim 1, wherein the turning angle is an obtuse angle.

8. The high frequency connector of claim 1, wherein the impedance adjusting element further comprises a protruding portion, and the housing comprises a through hole configured to engage with the protruding portion.

9. The high frequency connector of claim 1, wherein the impedance adjusting element further comprises a sliding block, and the housing comprises a sliding groove configured to engage with the sliding block.

10. The high frequency connector of claim 1, wherein the impedance adjusting element further comprises a top surface in contact with the first insulative carrier or the second insulative carrier.
